(19) United States
(12) Patent Application Publication
(10) Pub. No.: US 2013/0233435 A1
(43) Pub. Date: Sep. 12, 2013

(54) INTEGRAL COUPLING FOR JOINING CONDUIT SECTIONS

(71) Applicants: Kevin Henthorn, Woodridge, IL (US); Giulio Scartozzi, Chicago Heights, IL (US); James E. Florek, New Lenox, IL (US)

(72) Inventors: Kevin Henthorn, Woodridge, IL (US); Giulio Scartozzi, Chicago Heights, IL (US); James E. Florek, New Lenox, IL (US)

(73) Assignee: ATKORE INTERNATIONAL, INC., Harvey, IL (US)

(21) Appl. No.: 13/417,230

(22) Filed: Mar. 10, 2012

(51) Int. Cl. F16L 9/22; B23P 19/00

(52) U.S. Cl. 138/155; 138/177; 29/428

(57) ABSTRACT

A coupling system for conduit and pipe is disclosed. First and second conduit sections are disclosed, each of which has first and second ends. The first end has an outside diameter, and the second end has a belled portion with an inside diameter greater than the outside diameter of the first end. The belled portion has an aperture and a raised lip surrounding the aperture. A threaded fastener is rotatably disposed in the aperture and engages threads of the aperture and an inner surface of the raised lip. The raised lip has a predetermined lip height that is selected to provide a minimum number of full threads engagement between the belled portion and the threaded fastener to ensure the belled portion has a predetermined pull out strength. Other embodiments are disclosed and claimed.

### BACKGROUND OF THE INVENTION

1. Field of the Invention

Embodiments of the invention generally relate to the field of coupling systems for conduit and pipe used to contain electrical cable or wiring, and more particularly to an improved conduit coupling assembly for connecting multiple lengths of electrical conduit in coaxial relationship.

2. Discussion of Related Art

It is a conventional practice in many types of pipe or conduit systems, and particularly in electrical systems employing tubular conduits that contain electrical wires or cables, to connect a number of lengths of conduit in end-to-end relation through means of couplings so as to form a continuous conduit system as desired for a particular application. In the case of thin wall conduit, which is primarily employed for encasing electrical cable or conductor wires in applications where the conduit will not be subjected to large stresses, compression fittings or coupling assemblies may be employed which are swaged or otherwise affixed to adjacent ends of conduit lengths. The conduit is generally available in different lengths and may be quite readily formed to various bend contours and coupled end-to-end through the compression couplings or coupling assemblies.

One known technique for connecting lengths of conduit in coaxial or end-to-end relationship is to provide external threads of standard size on the opposite ends of each length of conduit and then connect the lengths of conduit through coupling assemblies. The coupling assemblies have internal threads which enable threaded connection with adjacent ends of the conduit lengths to form a structurally sound and electrically sound connection.

Such coupling assemblies typically require specially manufactured components, including outer and inner coupling assemblies that must be first installed on each length of conduit before the lengths of conduit can be joined. More specifically, these coupling assemblies utilize outer and inner coupling members having threaded ends for threading onto the ends of the lengths of conduit. The outer coupling member is threaded or screwed on to one end of one length of conduit and the inner coupling member is threaded or screwed onto one end of the other length of conduit. The lengths of conduits are then axially aligned and the inner coupling member is inserted into the outer coupling member. The inner coupling member is firmly held in the outer coupling member by set screws disposed on the outer coupling member.

Other known coupling assemblies require specially manufactured components, including outer and inner coupling members that must be first installed on one length of conduit before the lengths of conduit can be coupled together. Those outer and inner coupling members have threaded ends and the lengths of conduit are subsequently joined by rotating the outer coupling member to thread or screw it onto the other end length of conduit.

As can be appreciated, each of the aforementioned schemes suffer from issues relating to greater-than-desired cost, and complexity of installation process. Thus, there is a need for an improved conduit coupling arrangement that reduces the total number components, is easy to install, and still ensures a high integrity connection exists between adjacent sections of conduit.

### SUMMARY OF THE INVENTION

An integral set screw coupling assembly is disclosed for efficiently connecting sections of conduit in coaxial relation. The disclosed assembly reduces the amount of time needed to tighten the screws or bolts during the conduit installation process, reduces or eliminates the amount of offset typically caused when several conduits are assembled and joined together enhances the mechanical connection between the lengths of conduit, and increases the safety of the conduit system by eliminating or reducing any damage of the electrical cable at the connection joint between the length of conduit.

A conduit section is disclosed. The conduit section has a first end and a second end. The first end has an outside diameter, and the second end has a belled portion with an inside diameter that is greater than the outside diameter of the first end. The belled portion has an aperture through a wall of the belled portion. The aperture is in communication with an inside surface of the conduit section and an outside surface of the conduit section. A raised lip surrounds the aperture and has a predetermined lip height. An inner surface of the wall forming the aperture includes threads, as does an inner surface of the raised lip. These threads are configured to engage threads of an externally threaded fastener.

A conduit assembly is disclosed. The conduit assembly includes first and second conduit sections. Each of said first and second conduit sections has a first end and a second end. The first end has an outside diameter, and the second end has a belled portion with an inside diameter that is greater than the outside diameter of the first end. The belled portion further includes an aperture through a wall thereof. The aperture is in communication with an inside surface of the conduit section and an outside surface of the conduit section. A raised lip surrounds the aperture. The raised lip has a predetermined lip height. The assembly further includes a threaded fastener having an externally threaded portion, a portion of which is positioned in the aperture in the belled portion. Internal threads are disposed on an inner surface of the wall forming the aperture and an inner surface of said raised lip. These internal threads are configured to engage the external threads of the threaded fastener.

A method is disclosed for joining conduit sections. The method includes: (a) providing a first conduit section having first and second ends, the first end having a belled portion with an inside diameter, the belled portion further having an aperture formed in a wall thereof, the aperture having a raised lip portion disposed about the aperture on an outer surface of the belled portion, the raised lip portion having an upper surface disposed a first distance from the inside diameter; (b) providing a second conduit section having first and second ends, the second end having an outside diameter smaller than the inside diameter of the belled portion; (c) inserting the second end of the second conduit section into the belled portion of the first conduit section to position the first and second conduit sections in substantially coaxial alignment; and (d) rotating a threaded fastener within the aperture until a distal end of the fastener engages an outer surface of the second conduit section.

### BRIEF DESCRIPTION OF THE DRAWINGS

The accompanying drawings illustrate preferred embodiments of the disclosed device so far devised for the practical application of the principles thereof, and in which:

FIG. 1 is an isometric view of two lengths of conduit connected using the disclosed connection arrangement;

FIG. 2 is a reverse isometric view of a portion of conduit employing the disclosed connection arrangement;

FIG. 3A is a cross-section view of the portion of conduit of FIG. 2 taken along line 3A-3A of FIG. 2;

FIG. 3B is a cross-section view of the portion of conduit of FIG. 2 taken along line 3B-3B of FIG. 2;

FIG. 3C is a cross-section view of the portion of conduit of FIG. 2 taken along line 3C-3C of FIG. 2;

FIG. 4A is a top plan view of the portion of conduit of FIG. 2 in combination with an exemplary fastener;

FIG. 4B is an end view of the portion of conduit of FIG. 4A; and

FIG. 4C is a cross-section view of the portion of conduit of FIG. 4A, taken along line 4C-4C of FIG. 4A.

### DESCRIPTION OF EMBODIMENTS

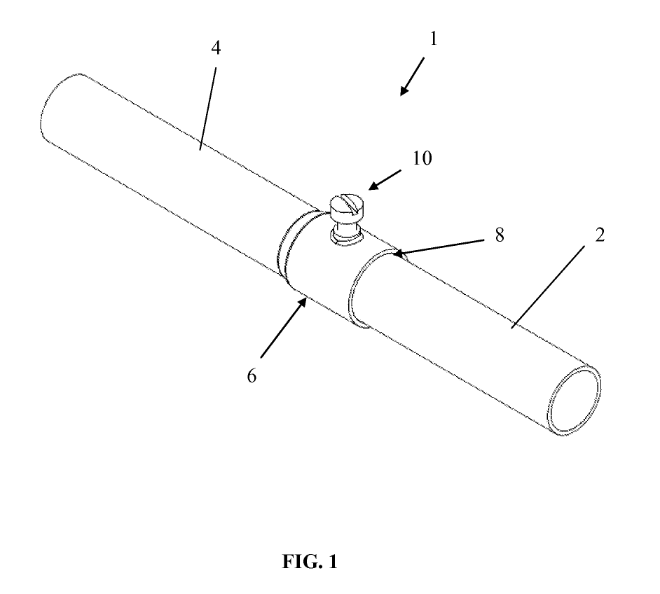

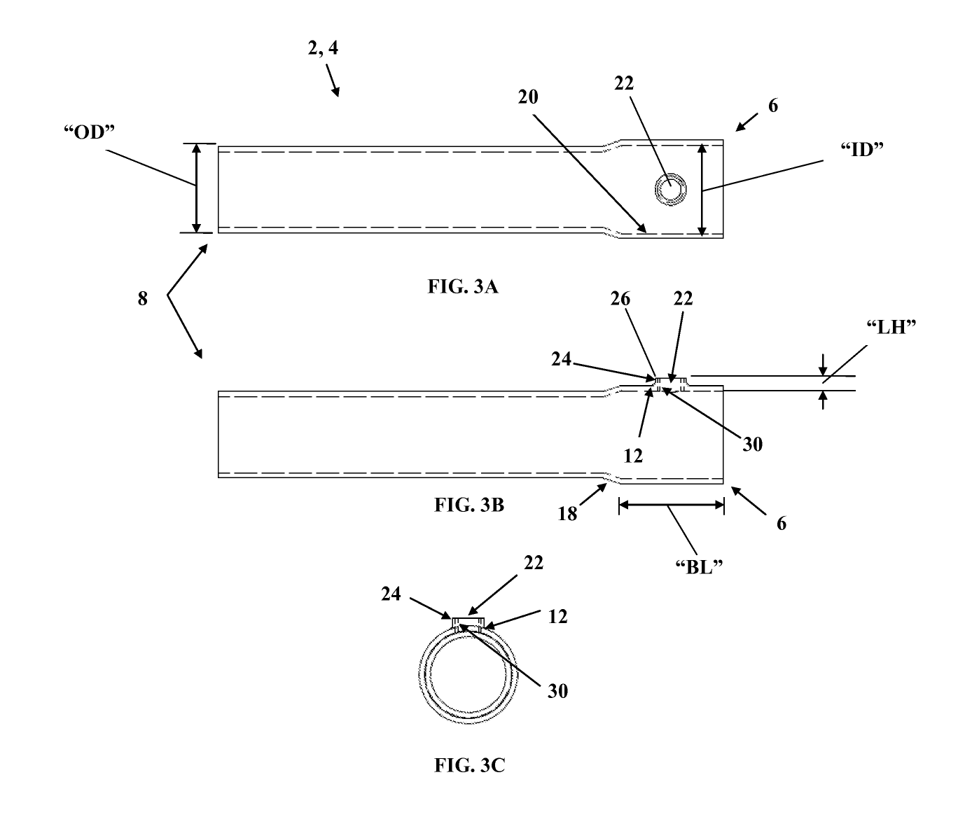

FIG. 1 shows an exemplary coupling assembly 1 for connecting first and second conduit sections 2, 4 in generally coaxial relationship. The first and second conduit sections 2, 4 can have generally the same outer diameter, and can be of the same or different lengths. At least one of the sections 2, 4 has a bell portion 6 configured to receive an insertion end 8 of the other section. The bell portion 6 has an inner diameter (“ID” FIG. 3A) sized to receive the outer diameter (“OD” FIG. 3A) of the insertion end 8 of the other conduit section.

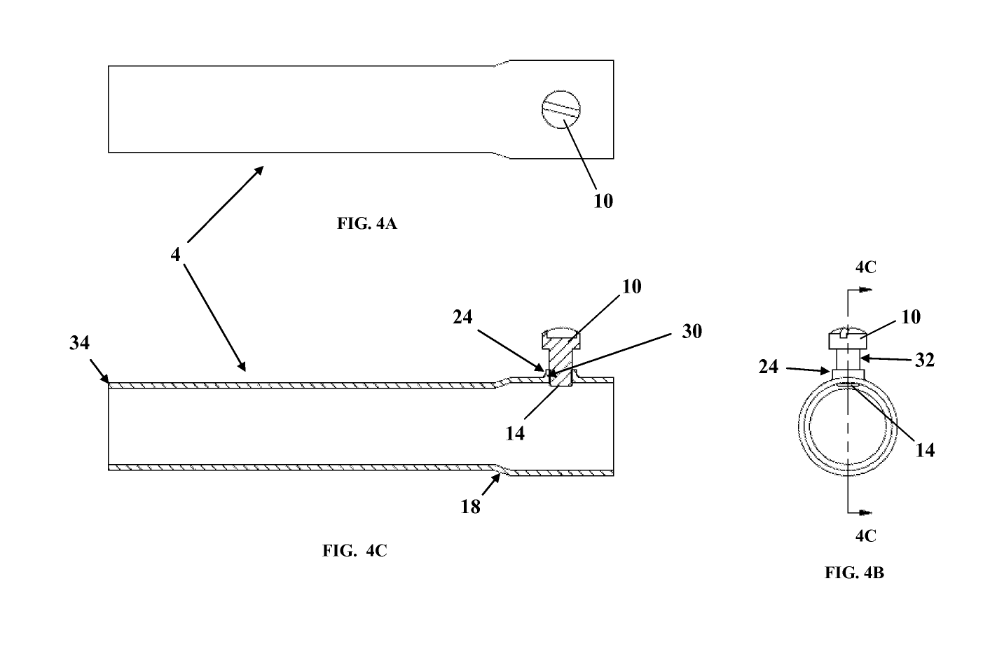

To fix the coupling sections 2, 4 together, a fastener 10 is disposed in a wall 12 (FIGS. 3B, 3C) of the bell portion 6 so that a first end 14 (FIGS. 4B, 4C) of the fastener 10 is engageable with an outer surface 16 of the insertion end 8. This arrangement facilitates easy selective locking/unlocking of the first and second conduit sections 2, 4 with respect to each other. As will be appreciated, the disclosed arrangement also provides a distinct advantage over prior designs because the coupling is integrally formed in the conduit sections 2, 4, which eliminates the need for additional coupling components. This reduces manufacturing costs and installation time. It will be appreciated that although the illustrated embodiment shows the first coupling section 2 without a bell portion 6, in practical application both coupling sections 2, 4 will include a bell portion 6.

In addition, although the illustrated embodiment shows a single fastener 10 disposed in a wall 12 of the bell portion 6, embodiments are contemplated in which more than one fastener is provided. Such arrangements could be used with larger conduit sizes and/or where additional holding strength is desired. Thus, in some embodiments a second fastener can be provided in line with (i.e., axially aligned) with the fastener 10. Alternatively, the second fastener could be radially offset from the fastener 10. Combinations of axial and radial offsets are also contemplated. The second fastener may be the same size as the fastener 10, or the two may be of different sizes. For example, the second fastener could be larger than the fastener 10. In addition, where the fastener and the second fastener are threaded fasteners, they may have different thread sizes and/or thread profiles.

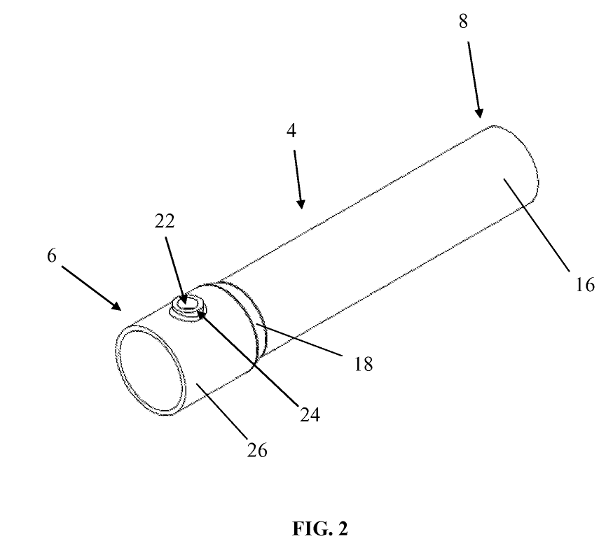

FIG. 2 is a reverse isometric view of an exemplary conduit section 2, 4 showing the insertion end 8 transitioning to the bell portion 6 at a transition region 18. The transition region 18 serves as an abutment that limits the extent to which that the insertion end 8 of one conduit section can be inserted into the bell portion 6 of the other conduit section.

In one embodiment, the insertion end 8 and the bell portion 20 are sized so that when the insertion end 8 of one conduit section is inserted into the bell portion 6 of the other conduit section, the clearance between the outer surface 16 of the insertion end 8 and the inner surface 20 (FIG. 3A) of the bell portion 6 is minimized. Minimizing this clearance is desirable, and is balanced against the desire to provide conduit sections that are easily fit together.

Exemplary values for the bell portion 6 inner diameter (“ID”) and the insertion end 8 outer diameter (“OD”) are as follows:

| | REQUIRED |
|---|---|
| OD | EXP. ID |
| .706″ | 0.716-0.731 |
| .922″ | 0.932-0.952 |
| 1.163″ | 1.173-1.193 |

As will be appreciated, providing dimensions of this magnitude between the outer surface 16 of the insertion end 8 and the inner surface 20 of the bell portion 6 provides an improved mechanical fit between the first and second conduit sections 2, 4. Moreover, the reduced gap reduces or eliminates dimpling, which can occur on the insertion end 8 when the first and second lengths of conduit 2, 4 are coupled. Providing such clearance of also facilitates easy engagement of the conduit sections, and reduced the amount of time needed to tighten the fastener 10 during the conduit assembly process.

In addition, this reduced clearance between the outer surface 16 of the insertion end 8 and the inner surface 20 of the bell portion 6 reduces or eliminates the amount of offset that can occur when several conduit sections are joined together. With prior designs, a large degree of “slop” may exist between the conduit sections and the associated fittings, which can stack up during installation to result in a conduit run that is not straight. With the disclosed design, even where stack up does occur, its impact is minimal due to the reduced clearance between conduit sections. Thus, the entire length will remain substantially aligned in co-axial relation and the central axes of the several conduit sections will define a substantially straight line.

Referring to FIGS. 3A-3C, the bell portion 6 has an aperture 22 formed in wall 12. A raised lip 24 is disposed circumferentially around the aperture 22. This raised lip 24 has an upper surface 26 disposed above the outer surface 28 of the bell portion 6 to provide the raised lip 24 with a lip height “LH.” This lip height “LH” is measured as the distance between the inner surface 20 of the bell portion 6 and the upper surface 26 of the raised lip 24. An inner surface 30 of the raised lip 24 is threaded to cooperate with corresponding external threads 32 of the fastener 10.

The raised lip 24 is formed to provide a predetermined lip height “LH” that will accommodate a desired number of full threads of engagement between the aperture threads and the fastener threads 32. In one embodiment, a minimum of two full threads of engagement are provided. By providing this minimum level of engagement between the fastener threads and the raised lip threads, a desired pull strength can be imparted to the fastener/lip connection.

Providing sufficient thread engagement is important because it reduces the chance that the threads in the wall 12 will strip when the fastener 10 is tightened. For example, if, as with prior designs, a hole were simply drilled in the wall 12 of the bell portion 6, the resulting wall thickness would be too small to provide adequate threaded engagement between the fastener and the aperture, in order to reliably lock the conduit sections together. In addition to providing inadequate engagement strength, such prior arrangements are also overly susceptible to thread stripping, as the installer tightens the fastener 10 to lock the conduit sections 2, 4 together. This is particularly true where the bell portion 6 is formed using an expander, since expansion reduces the wall of the tube from its original thickness. Once the threads are stripped, it is necessary either to drill and thread a new hole in the bell portion 6, or to discard the conduit section.

In one embodiment, the fastener 10 is a set screw. The set screw may be of the type which can be advanced using an Allen wrench or may have any other suitable extending head for engagement by a suitable wrench, screwdriver, or the like. In one embodiment, the set screw can have a barbed or serrated tip for scoring the outer surface 16 of the insertion end 8 of the conduit. The underside surfaces of the head of the fastener 10 may also contain a serrated pattern or other suitable pattern to provide enhanced frictional engagement between the upper surface 26 of the raised lip 24 and the underside surface of the head of the fastener 10. Such a construction provides a positive locking between the raised lip 24 and the fastener 10 when the fastener is in a tightened position and prevents the fastener from vibrating loose from a tightened position during use.

In one embodiment, the inner surface 30 of the raised lip 24 may be tapped to provide a desired thread profile for matching the threads 32 of the fastener 10. Alternatively, the fastener 10 may have self-tapping threads, in which case the inner surface 30 may not be tapped prior to introduction of the fastener 10.

During assembly of multiple lengths of conduit 2, 4, the insertion end 8 is positioned into the bell portion 6 until the insertion end 8 abuts the transition 18. The fastener 10 is then tightened to mechanically couple the lengths of conduit 2, 4 together. The aperture 22 containing the fastener 10 may be located a sufficient distance from the transition 18 and a leading edge 34 of the insertion end 8 so that when the fastener is tightened, any dimpling that may occur on the insertion end 8 will be reduced or eliminated. In one embodiment, the center of the aperture is located at least about 0.56 inches from the end 40 of the transition 18 for a ½-inch nominal conduit, is located at least about 0.60 inches from the end 40 of the transition 18 for a ¾-inch nominal conduit, and is located at least about 0.66 inches from the end 40 of the transition 18 for a 1-inch nominal conduit.

Further, the center of the aperture 22 is located at least about 0.375 inches from the leading edge 34 of the insertion end 8 for a ½-inch nominal conduit, may be located at least about 0.400 inches from the leading edge 34 of the insertion end 8 for a ¾-inch nominal conduit, and is located at least 0.540 inches from the leading edge 34 of the insertion end 8 for a 1-inch nominal conduit. In one embodiment, the fastener 10 is a 12-28 threads/per inch-inch set screw with a double or triple lead thread, or other suitable broad thread design. In addition, the fastener 10 may have a thread profile of between 10-24 and 12-28 threads per inch, and a length of about 5/32 inches to ¼-inch. The thread profile and the length of each fastener 10 should be dimensioned such that only about a ¼ to 1½ turn of the fastener 10 is needed to adequately engage the insertion end 8 of the cooperating conduit section. In addition, the length of the fastener 10 should be sized so that when the fastener 10 is fully engaged with the cooperating conduit section, the head of the fastener 10 fits firmly and securely on the upper surface 26 of the raised lip 24.

The disclosed arrangement enables an operator to quickly and efficiently tighten the screw against the outer surface of the insertion end of the conduit. In addition, the disclosed arrangement eliminates guesswork involved in determining whether the fastener 10 is in the locked/tightened position as well as in determining whether enough torque has been applied to adequately tighten the fastener 10. Moreover, this construction reduces or eliminates the possibility that dimpling will occur on the insertion end 8 caused by over tightening of the fastener 10, and it reduces or eliminates the possibility that the fastener 10 will vibrate loose during use.

Referring to FIG. 3B, the nominal length “BL” of the bell portion 6 (i.e., the distance from the edge of the length of conduit 2, 4 on the receiving end to the transition region 18) should be at least 0.95 inches for a ½-inch nominal conduit, at least 1.00-inches for a ¾-inch nominal conduit, and at least 1.20-inches for a 1-inch nominal conduit to provide an efficient mechanical fit. It will be appreciated that increasing the amount of surface area of the bell portion 6 in contact with the insertion end 8 improves the mechanical connection between the two. This improved mechanical connection must, however, be weighed against the desire to exploit as much of the usable lengths of the conduit sections 2, 4 as practical.

In one embodiment, the bell portion 6 is formed using an expander, which is inserted into an unexpanded end of the conduit section 2, 4 until a bell portion 6 having a desired length “BL” is formed. After the bell expansion step, the conduit section 2, 4 may be fixed at a station where the aperture 22 and raised lip 24 are formed. In one embodiment, the aperture 22 and raised lip 24 are formed in a single operation, with the aperture being punched out from the interior of the conduit. In another embodiment, the aperture 22 and raised lip 24 may be formed in separate operations. For example, the aperture 22 may be drilled, followed by the application of one or more weld-beads of material surrounding the aperture to form the raised lip 24 having a desired lip height “LH.” The aperture 22 (including the interior surface 30 of the raised lip 24) may then be tapped to provide a desired interior thread profile. Alternatively, where self tapping fastener is used, the aperture and interior surface 30 of the raised lip 24 may be left untapped. A fastener 10 may then be installed in the aperture 22.

While the invention has been disclosed with reference to certain embodiments, numerous modifications, alterations and changes to the described embodiments are possible without departing from the spirit and scope of the invention, as defined in the appended claims. Accordingly, it is intended that the present invention not be limited to the described embodiments, but that it has the full scope defined by the language of the following claims, and equivalents thereof.

What is claimed is:

1. A conduit section, comprising:
a conduit section having a first end and a second end, the first end having an outside diameter, the second end including a belled portion having an inside diameter that is greater than the outside diameter of the first end;
the belled portion having an aperture through a wall of the belled portion, the aperture in communication with an inside surface of the conduit section and an outside surface of the conduit section; and
a raised lip surrounding the aperture, the raised lip having a predetermined lip height;
wherein an inner surface of said wall forming said aperture and an inner surface of said raised lip include threads configured to engage threads of an externally threaded fastener.

2. The conduit section of claim 1, wherein the predetermined lip height is measured from the inside diameter of the belled portion to an upper surface of the raised lip.

3. The conduit section of claim 2, wherein the predetermined lip height is about 0.040 inches to 0.080 inches.

4. The conduit section of claim 1, wherein the inside diameter of the belled portion is about 0.010-0.020 inches greater than the outside diameter of the first end.

5. The conduit section of claim 1, further comprising a transition region disposed between the first end and the belled portion.

6. The conduit section of claim 1, wherein the transition region forms an inner abutment.

7. The conduit section of claim 1, wherein the predetermined lip height is selected to provide a predetermined number of full threads of engagement between the threads of the aperture and raised lip, and the threads of the externally threaded fastener.

8. The conduit section of claim 1, wherein the belled portion has first and second apertures through the wall of the belled portion, the first and second apertures in communication with the inside surface of the conduit section and the outside surface of the conduit section;
wherein the belled portion has first and second raised lips surrounding the first and second apertures, respectively, the first and second raised lips each having a predetermined lip height; and
wherein an inner surface of the wall forming the second aperture and an inner surface of said second raised lip include threads configured to engage threads of a second externally threaded fastener

9. A conduit assembly, comprising:
first and second conduit sections, each of said first and second conduit sections having a first end and a second end, the first end having an outside diameter, the second end including a belled portion having an inside diameter that is greater than the outside diameter of the first end;
the belled portion having an aperture through a wall thereof, the aperture in communication with an inside surface of the conduit section and an outside surface of the conduit section;
a raised lip surrounding the aperture, the raised lip having a predetermined lip height; and
a threaded fastener having an externally threaded portion, a portion of the threaded fastener positioned in the aperture;
wherein an inner surface of said wall forming said aperture and an inner surface of said raised lip include internal threads configured to engage the external threads of the threaded fastener.

10. The conduit assembly of claim 9, wherein the predetermined lip height is measured from the inside diameter of the belled portion to an upper surface of the raised lip.

11. The conduit assembly of claim 10, wherein the predetermined lip height is about 0.040 inches to 0.080 inches.

12. The conduit assembly of claim 9, wherein the inside diameter of the belled portion is about 0.010-0.020 inches greater than the outside diameter of the first end.

13. The conduit assembly of claim 9, further comprising a transition region disposed between the first end and the belled portion.

14. The conduit assembly of claim 9, wherein the transition region forms an inner abutment.

15. The conduit assembly of claim 9, wherein the predetermined lip height is selected to provide a predetermined number of full threads of engagement between the internal threads of the aperture and raised lip, and the external threads of the threaded fastener.

16. The conduit assembly of claim 9, further comprising a second threaded fastener having an externally threaded portion,
wherein the belled portion has first and second apertures through the wall of the belled portion, the first and second apertures in communication with the inside surface of the conduit section and the outside surface of the conduit section;
wherein the belled portion has first and second raised lips surrounding the first and second apertures, respectively, the first and second raised lips each having a predetermined lip height;
wherein an inner surface of the wall forming the second aperture and an inner surface of said second raised lip include threads configured to engage threads of a second externally threaded fastener; and
wherein a portion of the second threaded fastener is positioned in the aperture.

17. A method for joining conduit sections, comprising:
providing a first conduit section having first and second ends, the first end having a belled portion with an inside diameter, the belled portion further having an aperture formed in a wall thereof, the aperture having a raised lip portion disposed about the aperture on an outer surface of the belled portion, the raised lip portion having an upper surface disposed a first distance from the inside diameter;
providing a second conduit section having first and second ends, the second end having an outside diameter smaller than the inside diameter of the belled portion;
inserting the second end of the second conduit section into the belled portion of the first conduit section to position the first and second conduit sections in substantially coaxial alignment; and
rotating a threaded fastener within the aperture until a distal end of the fastener engages an outer surface of the second conduit section.

18. The method of claim 17, wherein the threaded fastener is a self tapping screw, and rotating the threaded fastener comprises cutting threads in an inner surface of said wall and an inner surface of said raised lip portion.

19. The method of claim 17, wherein:
each of the first and second conduit sections includes a transition region between the belled portion and the second end;
the transition region of each of the first and second conduit sections forms an inner abutment;
wherein inserting the second end of the second conduit section into the belled portion of the first conduit section comprises inserting the second end of the second conduit section until the second end engages the inner abutment of the first conduit section.

20. The method of claim 17, wherein the first distance is selected to provide a predetermined number of full threads of engagement between the belled portion and the threaded fastener.

21. The method of claim 20, wherein the first distance is about 0.090-inches to 0.120-inches.

22. The method of claim 17, wherein rotating a threaded fastener within the aperture until a distal end of the fastener engages an outer surface of the second conduit section does not dimple the second conduit section.

23. The method of claim 17, wherein the belled portion has first and second apertures formed in the wall thereof, the first and second apertures having first and second raised lip portions disposed about the respective first and second aperture on an outer surface of the belled portion, the first and second raised lip portions each having an upper surface disposed a first distance from the inside diameter; and
wherein the rotating step includes rotating first and second threaded fasteners within the first and second apertures, respectively, until distal ends of the first and second fasteners engage the outer surface of the second conduit section
